(19) United States
(12) Patent Application Publication
(10) Pub. No.: US 2014/0281549 A1
(43) Pub. Date: Sep. 18, 2014

(54) METHODS AND APPARATUS FOR SECURING USER INPUT IN A MOBILE DEVICE

(71) Applicant: StrikeForce Technologies, Inc., Edison, NJ (US)

(72) Inventor: Ram Pemmaraju, Old Bridge, NJ (US)

(73) Assignee: StrikeForce Technologies, Inc., Edison, NJ (US)

(21) Appl. No.: 14/214,727

(22) Filed: Mar. 15, 2014

Related U.S. Application Data
(60) Provisional application No. 61/794,621, filed on Mar. 15, 2013.

(51) Int. Cl. H04L 29/06; H04W 12/04; H04L 9/08

(52) U.S. Cl. CPC H04L 63/061; H04L 9/0861; H04W 12/04
USPC 713/171

(57) ABSTRACT

The present invention secures user data throughout its lifecycle—(1) when entering data into the mobile device, (2) when storing the data in the mobile device, and (3) when transmitting data from the mobile device. In accordance with a first aspect of the invention, the invention features a methodology for encrypting and passing the keystrokes to the application in an encrypted format. In accordance with a second aspect of the invention, the invention features a methodology to store data in a vault in an encrypted form and launch an application with the data from the vault. In accordance with a third aspect of the invention, the invention features a methodology to transmit data from the mobile device to an external application securely.

### REFERENCE TO RELATED APPLICATION

The present application claims the benefit of U.S. Provisional Patent Application No. 61/794,621, filed Mar. 15, 2013, whose disclosure is hereby incorporated by reference in its entirety into the present disclosure.

### BACKGROUND OF THE INVENTION

1. Field of the Invention

The present invention relates generally to all mobile device security and, more particularly, to a method and apparatus of securing data entered in all mobile devices, such as smart phones, tablets, etc.

2. Description of the Related Art

Mobile devices, such as smart phones and tablets are starting to augment/replace the corporate desktop, especially in the light of Bring Your Own Device (BYOD). In this new role, the mobile device becomes the focus of attackers for stealing corporate usernames and passwords leading to data breaches, which leads to large dollar losses and unwanted headlines. Hence, protecting data in a mobile framework becomes critical.

The top mobile security issues can be grouped around—

Device loss—Loss of a mobile device, whether accidental or due to theft is one of the top concerns. Fortunately, mobile device vendors have included capabilities to locate the device and wipe the data remotely.

Application privacy—Rogue applications can trick a user into granting them privileges that enable them to access various data sources on the device. These can include device identification data, call and message history, contents of the address book, geo-location data and browsing history. In addition, mobile operating systems log a user's keystrokes to help in auto-completion.

Malware—Malware can be disguised as a rogue application and steal confidential data using attack modules such as a keylogger.

The defenses against these threats are limited due to the restrictions imposed by the mobile operating system. Thus it is hard to detect malware and defend against it.

### SUMMARY OF THE INVENTION

The present invention focuses on securing user data, especially during data entry, rather than trying to detect malware.

The present invention secures user data throughout its lifecycle—(1) when entering data into the mobile device, (2) when storing the data in the mobile device, and (3) when transmitting data from the mobile device.

The invention in various embodiments includes one or more of the following components—(1) Custom On-Screen Keyboard, (2) Message Filter, (3) Custom Browser, (4) Pre-Filter, (5) Post-Filter, (6) Data Vault, (7) Biometric Store, (8) Certificate Store, (9) One Time Password Generator, and (10) Malware Analyzer.

Securing data entry is done by encrypting and passing the keystrokes directly to applications in an encrypted format. The application decrypts the keystroke before it is displayed. Thus, the present invention enables the user to enter sensitive information (passwords, credit card numbers, etc.) without the keystrokes being intercepted by keyloggers.

A data vault (i.e. database) stores the data securely in the mobile device. All data in the vault is stored in an encrypted form. The vault allows the data to be categorized. Also, the schema related to a particular entry can be dynamically changed. The vault also binds a particular entry to an application, either locally on the mobile device or to an application external to the device such that the entries related to an item can be automatically entered into the application.

Data is transmitted from the mobile device to an external application securely. The data is encrypted at the point of data entry and decrypted either at a local application on the mobile device, at the remote application or at a point midway between the local application and the remote application.

In accordance with a first aspect of the invention, the invention features a methodology for encrypting and passing the keystrokes to the application in an encrypted format.

In accordance with a second aspect of the invention, the invention features a methodology to store data in a vault in an encrypted form and launch an application with the data from the vault.

In accordance with a third aspect of the invention, the invention features a methodology to transmit data from the mobile device to an external application securely.

### BRIEF DESCRIPTION OF THE DRAWINGS

Preferred embodiments of the invention will be set forth with reference to the drawings, in which:

FIG. 1 depicts the components of the preferred embodiments;

FIG. 2 depicts the methodology to process keystrokes on a mobile device today;

FIG. 3 depicts one embodiment of the invention;

FIG. 4 depicts another embodiment of the invention;

FIG. 5 depicts yet another embodiment of the invention;

FIG. 6 depicts the methodology of a data vault today; and

FIG. 7 depicts one embodiment of the invention.

### DETAILED DESCRIPTION OF THE PREFERRED EMBODIMENTS

Exemplary embodiments of the invention are described herein in terms of processes. Efficient prototypes of such processes have been implemented as software on general-purpose hardware.

FIG. 1 depicts the components of the preferred embodiments of the invention—Custom On-Screen Keyboard 101, Message Filter 102, Custom Browser 103, Pre-Filter 104, Post-Filter 105, Data Vault 106, Biometric Store 107, Certificate Store 108, One Time Password Generator 109, and Malware Analyzer 110. The above and other components can be implemented in a mobile device 100 (smartphone, tablet, or the like) having a processor 100a and a persistent memory 100b storing code that, when executed on the processor 100a, implements the above components and any other desired functionality.

The Custom On-Screen Keyboard 101 encrypts the key pressed and generates a key event message (such as key up, key down and key press events). The message contains information (such as scan codes, virtual key codes and character codes) on the key pressed. The Custom On-Screen Keyboard 101 can be a modified version of the native On-Screen Keyboard 112 with or without extra buttons or input boxes for additional functionality. It can also be a non-native keyboard, for example a keyboard implemented in Javascript.

The Message Filter 102 gets the unencrypted key event and encrypts it.

The Custom Browser 103 enables secure access to web pages. It decrypts the keystrokes, has the capability to parse the web page to indicate encrypted input fields by means of a background color which can be selected by the user via a preference setting. The parsing also enables the detection of hidden iframes to check for click-jacking attacks. The Custom Browser 103 also communicates with a Malware Analyzer 110 to analyze the contents of the web page for any malware.

The Pre-Filter 104 processes the input data from the Custom On-Screen Keyboard 101, decrypts the key event messages, and re-encrypts the data in a format suitable for storing in the Data Vault 106.

The Post-Filter 105 decrypts the data coming out of the Data Vault 106 and launches the Custom Browser 103 or Application 111 with the appropriate data from the data vault.

The Data Vault 106 can be either a database or a directory suitable for storing user data. It has the capability to allow the user to modify the schema dynamically.

The Biometric Store 107 has the capability to allow the user to store any of their biometric information such as fingerprint, voiceprint, faceprint and irisprint. Alternatively, it may link to an existing biometric store either internally on the mobile device or externally.

The Certificate Store 108 has the capability to allow the user to store PKI certificates. Alternatively, it may link to an existing certificate store either internally on the mobile device or externally.

The One Time Password generator 109 has the capability to generate one time passwords which are either counter based or time based. The algorithm used to generate the one time passwords could be proprietary or based on a standard such as OATH and can support third-party OATH-compliant soft tokens, provisioned either manually or through a QR code. In addition, or instead, strong passwords can be created based on user-defined preferences and stored in a password vault, which securely stores an unlimited number of passwords with associated websites, for future use.

The Malware Analyzer 110 has the capability to analyze the contents received by the Custom Browser 103 to determine if they contain malware (i.e. viruses, spyware, trojans, botnets, rootkits, keyloggers, etc.) or the web page has links to malicious sites. Alternatively, it may link to an existing malware analysis service external to the device.

In accordance with a first aspect of the invention, the invention features a methodology for encrypting and passing the keystrokes to the application in an encrypted format.

FIG. 2 depicts the methodology to process keystrokes on a mobile device today. When a key is pressed on the On Screen Keyboard 112, a key event message (such as key up, key down and key press events) is created 115. The message contains information (such as scan codes, virtual key codes and character codes) on the key pressed. The message is retrieved by the Application 111 which displays the keystroke.

FIG. 3 depicts one embodiment of the invention. When a key is pressed on the On Screen Keyboard 112, a key event message is created 115. The message contains information on the key pressed. The contents of the message are encrypted by the Message Filter 102 that encrypts the contents of the message. The message is retrieved by the Application 111 which displays the keystroke after decrypting the message.

FIG. 4 depicts another embodiment of the invention. A Custom On Screen Keyboard 101 is used for data entry. When a key is pressed, the key is encrypted and then a key event message is generated 115. The message contains the key information in encrypted form. The message is retrieved by the Application 111 which displays the keystroke.

FIG. 5 depicts yet another embodiment of the invention. When a key is pressed on an External Keyboard 114 (for example a keyboard connected to the device externally), a key event message is created 115. The message contains information on the key pressed. The contents of the message are encrypted by the Message Filter 102 that encrypts the contents of the message. The message is retrieved by the Application 111 which displays the keystroke after decrypting the message.

In accordance with a second aspect of the invention, the invention features a methodology to store data in a vault in an encrypted form and launch an application with the data from the vault.

FIG. 6 depicts the methodology of a data vault today. A Data Entry form 116 is used to enter data into a Data Vault 106. A Data Retrieval form 117 is used to read the contents of the vault.

FIG. 7 depicts one embodiment of the invention. A Data Entry form 116 is used to enter data into a Data Vault 106. The data is intercepted, encrypted and processed by a Pre-Filter 104. A Data Retrieval form 117 is used to read the contents of the vault. The contents of the vault are intercepted by a Post-Filter 105 which launches an Application 111 based on the contents of the vault.

In accordance with a third aspect of the invention, the invention features a methodology to transmit data from the mobile device to an external application securely. Data is transmitted from the mobile device to an external application securely. The data is encrypted at the point of data entry and decrypted either at a local application on the mobile device, at the remote application or at a point midway between the local application and the remote application.

Although certain presently preferred embodiments of the present invention have been specifically described herein, it will be apparent to those skilled in the art to which the invention pertains that variations and modifications of the various embodiments shown and described herein may be made without departing from the spirit and scope of the invention. For instance, an embodiment can be modified to incorporate one or more features or another embodiment, or embodiments can be combined. Also, features disclosed separately can be used together, or vice versa. Accordingly, it is intended that the invention be limited only by the appended claims to the extent required by the applicable rules of law.

We claim:

1. A method for modifying keystrokes of a mobile device keyboard by intercepting key event messages generated by the mobile device keyboard via a filter module, encrypting contents of the key event messages, and sending the encrypted key event messages to an application where the encrypted key event messages are decrypted, said method comprising:
(a) intercepting the key event messages;
(b) processing the key event messages via the filter module;
(c) encrypting the key event messages;
(d) sending the encrypted key event messages to the application where the encrypted key event messages are decrypted;
(e) providing an interface to turn encryption of the key event messages on and off and turning the encryption on or off in accordance with an input into the interface; and
(f) indicating on the interface whether the encryption is turned on or off.

2. A method as claimed in claim 1, wherein said mobile device keyboard is selected from the group consisting of an onscreen keyboard implemented in software and a part of the mobile device implemented in hardware.

3. A method as claimed in claim 1, wherein step (a) comprises monitoring key event structures in memory.

4. A method as claimed in claim 1, wherein step (a) comprises hooking into a keyboard class driver.

5. A method as claimed in claim 1, wherein step (c) comprises using encryption keys selected from the group consisting of symmetric keys and asymmetric keys.

6. A method as claimed in claim 1, wherein step (d) is performed in-band and comprises passing the encrypted key event messages to a message queue of an operating system.

7. A method as claimed in claim 1, wherein step (d) is performed out-of-band and comprises passing a fake key event message to a message queue of an operating system which causes the application to retrieve the encrypted key event messages from the filter module.

8. A method as claimed in claim 1, wherein said application is a custom browser which decrypts the key event messages.

9. A method as claimed in claim 1, wherein said application is a standard browser with a plug-in that decrypts the key event messages.

10. A method as claimed in claim 1, wherein step (e) comprises monitoring a textbox that has focus.

11. A method as claimed in claim 1, wherein step (e) comprises providing a button in the application.

12. A method as claimed in claim 1, wherein step (f) comprises providing a colored input field.

13. A method as claimed in claim 1, wherein step (f) comprises providing an icon that has a steady or flashing color.

14. A method for encrypting keystrokes of a mobile device keyboard by using a custom on-screen keyboard and sending the keystrokes to an application where the keystrokes are decrypted, said method comprising:
(a) encrypting keys as the keys are pressed;
(b) generating encrypted key event messages;
(c) sending the encrypted key event messages to an application where the encrypted key event messages are decrypted;
(d) providing an interface to turn encryption of the key event messages on and off and turning the encryption on or off in accordance with an input into the interface; and
(e) indicating on the interface whether the encryption is turned on or off.

15. A method as claimed in claim 14, wherein said custom on-screen keyboard is a modified version of a native on-screen keyboard.

16. A method as claimed in claim 14, wherein said custom on-screen keyboard is implemented via Javascript.

17. A method as claimed in claim 14, wherein step (a) comprises using encryption keys selected from the group consisting of symmetric keys and asymmetric keys.

18. A method as claimed in claim 14, wherein step (c) is performed in-band and comprises passing the encrypted key event messages to a message queue of an operating system.

19. A method as claimed in claim 14, wherein step (c) is performed out-of-band and comprises passing a fake key event message to a message queue of an operating system which causes the application to retrieve the encrypted key event messages from a filter module.

20. A method as claimed in claim 14, wherein said application is a custom browser which decrypts the key event messages.

21. A method as claimed in claim 14, wherein said application is a standard browser with a plug-in that decrypts the key event messages.

22. A method as claimed in claim 14, wherein step (d) comprises monitoring a textbox that has focus.

23. A method as claimed in claim 14, wherein step (d) comprises providing a button in the application.

24. A method as claimed in claim 14, wherein step (e) comprises providing a colored input field.

25. A method as claimed in claim 14, wherein step (e) comprises providing an icon that has a steady or flashing color.

26. A method for modifying keystrokes of a keyboard connected externally to a mobile device by intercepting key event messages via a filter module, encrypting contents of the key event messages and sending the encrypted key event messages to an application where the encrypted key event messages are decrypted, said method comprising:
(a) intercepting the key event messages;
(b) processing the key event messages via the filter module;
(c) encrypting the contents of key event messages;
(d) sending the encrypted key event messages to the application where the encrypted key event messages are decrypted;
(e) providing a user interface to turn encryption of the key event messages on and off and turning the encryption on or off in accordance with an input into the interface; and
(f) indicating on the interface whether the encryption is turned on or off.

27. A method as claimed in claim 26, wherein said external keyboard is connected either in a wired fashion or wirelessly.

28. A method as claimed in claim 26, wherein step (a) comprises monitoring key event structures in memory.

29. A method as claimed in claim 26, wherein step (a) comprises hooking into a keyboard class driver.

30. A method as claimed in claim 26, wherein step (c) comprises using encryption keys selected from the group consisting of symmetric keys and asymmetric keys.

31. A method as claimed in claim 26, wherein step (d) is performed in-band and comprises passing the encrypted key event messages to a message queue of an operating system.

32. A method as claimed in claim 26, wherein step (d) is performed out-of-band and comprises passing a fake key event message to a message queue of an operating system which causes the application to retrieve the encrypted key event messages from the filter module.

33. A method as claimed in claim 26, wherein said application is a custom browser which decrypts the key event messages.

34. A method as claimed in claim 26, wherein said application is a standard browser with a plug-in that decrypts the key event messages.

35. A method as claimed in claim 26, wherein step (e) comprises monitoring a textbox that has focus.

36. A method as claimed in claim 26, wherein step (e) comprises providing a button in the application.

37. A method as claimed in claim 26, wherein step (f) comprises providing a colored input field.

38. A method as claimed in claim 26, wherein step (f) comprises providing an icon that has a steady or flashing color.

39. A method for storing data securely in a data vault, retrieving the data from the data vault and launching an application pre-populated with the data from the data vault, said method comprising:
(a) entering the data securely;
(b) storing the data securely;
(c) enabling a schema of a database or directory used to store the data to be dynamically modified; and
(d) launching at least one of a custom browser and an application pre-populated with the data.

40. A method as claimed in claim 39, wherein step (a) is performed using a keyboard that encrypts keystrokes.

41. A method as claimed in claim 39, wherein step (b) is performed via a Pre-Filter that encrypts and tags the data prior to storing the data in the database or directory.

42. A method as claimed in claim 41, wherein the data are encrypted using encryption keys selected from the group consisting of symmetric keys and asymmetric keys.

43. A method as claimed in claim 39, wherein step (c) comprises allowing the schema of the database or directory used to store the data to be dynamically modified to add/delete data fields.

44. A method as claimed in claim 39, wherein said data vault stores a user's login credentials (username and password) as well as details of the website or application.

45. A method as claimed in claim 44, wherein step (d) comprises launching the application or website with the login credentials pre-populated from the vault.

46. A method as claimed in claim 44, wherein the login credentials comprise at least one of a One-Time Password, a PKI certificate, and Biometric information.

47. A method as claimed in claim 44, wherein the login credentials are used to Single Sign-On to a website or the application.

48. A method as claimed in claim 39, wherein a webpage accessed through the custom browser is checked by a Malware Analyzer prior to being displayed.

49. A system for modifying keystrokes of a mobile device keyboard by intercepting key event messages generated by the mobile device keyboard via a filter module, encrypting contents of the key event messages, and sending the encrypted key event messages to an application where the encrypted key event messages are decrypted, said system comprising:
a processor; and
a persistent storage medium storing code for controlling the processor for:
(a) intercepting the key event messages;
(b) processing the key event messages via the filter module;
(c) encrypting the key event messages;
(d) sending the encrypted key event messages to the application where the encrypted key event messages are decrypted;
(e) providing an interface to turn encryption of the key event messages on and off and turning the encryption on or off in accordance with an input into the interface; and
(f) indicating on the interface whether the encryption is turned on or off.

50. A system as claimed in claim 49, wherein said system is configured such that said mobile device keyboard is selected from the group consisting of an onscreen keyboard implemented in software and a part of the mobile device implemented in hardware.

51. A system as claimed in claim 49, wherein the code comprises code for performing step (a) by monitoring key event structures in memory.

52. A system as claimed in claim 49, wherein the code comprises code for performing step (a) by hooking into a keyboard class driver.

53. A system as claimed in claim 49, wherein the code comprises code for performing step (c) by using encryption keys selected from the group consisting of symmetric keys and asymmetric keys.

54. A system as claimed in claim 49, wherein the code comprises code for performing step (d) in-band by passing the encrypted key event messages to a message queue of an operating system.

55. A system as claimed in claim 49, wherein the code comprises code for performing step (d) out-of-band by passing a fake key event message to a message queue of an operating system which causes the application to retrieve the encrypted key event messages from the filter module.

56. A system as claimed in claim 49, wherein the system is configured such that said application is a custom browser which decrypts the key event messages.

57. A system as claimed in claim 49, wherein the system is configured such that said application is a standard browser with a plug-in that decrypts the key event messages.

58. A system as claimed in claim 49, wherein the code comprises code for performing step (e) by monitoring a textbox that has focus.

59. A system as claimed in claim 49, wherein the code comprises code for performing step (e) by providing a button in the application.

60. A system as claimed in claim 49, wherein the code comprises code for performing step (f) by providing a colored input field.

61. A system as claimed in claim 49, wherein the code comprises code for performing step (f) by providing an icon that has a steady or flashing color.

62. A system for encrypting keystrokes of a mobile device keyboard by using a custom on-screen keyboard and sending the keystrokes to an application where the keystrokes are decrypted, said system comprising:
a processor; and
a persistent storage medium storing code for controlling the processor for:
(a) encrypting keys as the keys are pressed;
(b) generating encrypted key event messages;
(c) sending the encrypted key event messages to an application where the encrypted key event messages are decrypted;
(d) providing an interface to turn encryption of the key event messages on and off and turning the encryption on or off in accordance with an input into the interface; and
(e) indicating on the interface whether the encryption is turned on or off.

63. A system as claimed in claim 62, wherein the system is configured such that said custom on-screen keyboard is a modified version of a native on-screen keyboard.

64. A system as claimed in claim 62, wherein the system is configured such that said custom on-screen keyboard is implemented via Javascript.

65. A system as claimed in claim 62, wherein the code comprises code for performing step (a) by using encryption keys selected from the group consisting of symmetric keys and asymmetric keys.

66. A system as claimed in claim 62, wherein the code comprises code for performing step (c) in-band by passing the encrypted key event messages to a message queue of an operating system.

67. A system as claimed in claim 62, wherein the code comprises code for performing step (c) out-of-band by passing a fake key event message to a message queue of an operating system which causes the application to retrieve the encrypted key event messages from a filter module.

68. A system as claimed in claim 62, wherein the system is configured such that said application is a custom browser which decrypts the key event messages.

69. A system as claimed in claim 62, wherein the system is configured such that said application is a standard browser with a plug-in that decrypts the key event messages.

70. A system as claimed in claim 62, wherein the code comprises code for performing step (d) by monitoring a textbox that has focus.

71. A system as claimed in claim 62, wherein the code comprises code for performing step (d) by providing a button in the application.

72. A system as claimed in claim 62, wherein the code comprises code for performing step (e) by providing a colored input field.

73. A system as claimed in claim 62, wherein the code comprises code for performing step (e) by providing an icon that has a steady or flashing color.

74. A system for modifying keystrokes of a keyboard connected externally to a mobile device by intercepting key event messages via a filter module, encrypting contents of the key event messages and sending the encrypted key event messages to an application where the encrypted key event messages are decrypted, said system comprising:
a processor; and
a persistent storage medium storing code for controlling the processor for:
(a) intercepting the key event messages;
(b) processing the key event messages via the filter module;
(c) encrypting the contents of key event messages;
(d) sending the encrypted key event messages to the application where the encrypted key event messages are decrypted;
(e) providing a user interface to turn encryption of the key event messages on and off and turning the encryption on or off in accordance with an input into the interface; and
(f) indicating on the interface whether the encryption is turned on or off.

75. A system as claimed in claim 74, wherein the system is configured such that said external keyboard is connected either in a wired fashion or wirelessly.

76. A system as claimed in claim 74, wherein the code comprises code for performing step (a) by monitoring key event structures in memory.

77. A system as claimed in claim 74, wherein the code comprises code for performing step (a) by hooking into a keyboard class driver.

78. A system as claimed in claim 74, wherein the code comprises code for performing step (c) by using encryption keys selected from the group consisting of symmetric keys and asymmetric keys.

79. A system as claimed in claim 74, wherein the code comprises code for performing step (d) in-band by passing the encrypted key event messages to a message queue of an operating system.

80. A system as claimed in claim 74, wherein the code comprises code for performing step (d) out-of-band by passing a fake key event message to a message queue of an operating system which causes the application to retrieve the encrypted key event messages from the filter module.

81. A system as claimed in claim 74, wherein the system is configured such that said application is a custom browser which decrypts the key event messages.

82. A system as claimed in claim 74, wherein the system is configured such that said application is a standard browser with a plug-in that decrypts the key event messages.

83. A system as claimed in claim 74, wherein the code comprises code for performing step (e) by monitoring a textbox that has focus.

84. A system as claimed in claim 74, wherein the code comprises code for performing step (e) by providing a button in the application.

85. A system as claimed in claim 74, wherein the code comprises code for performing step (f) by providing a colored input field.

86. A system as claimed in claim 74, wherein the code comprises code for performing step (f) by providing an icon that has a steady or flashing color.

87. A system for storing data securely in a data vault, retrieving the data from the data vault and launching an application pre-populated with the data from the data vault, said system comprising:
a processor; and
a persistent storage medium storing code for controlling the processor for:
(a) entering the data securely;
(b) storing the data securely;
(c) enabling a schema of a database or directory used to store the data to be dynamically modified; and
(d) launching at least one of a custom browser and an application pre-populated with the data.

88. A system as claimed in claim 87, wherein the code comprises code for performing step (a) by using a keyboard that encrypts keystrokes.

89. A system as claimed in claim 87, wherein the code comprises code for performing step (b) via a Pre-Filter that encrypts and tags the data prior to storing the data in the database or directory.

90. A system as claimed in claim 89, wherein the code comprises code for encrypting the data using encryption keys selected from the group consisting of symmetric keys and asymmetric keys.

91. A system as claimed in claim 87, wherein the code comprises code for performing step (c) by allowing the schema of the database or directory used to store the data to be dynamically modified to add/delete data fields.

92. A system as claimed in claim 87, wherein the code comprises code for storing, in said data vault, a user's login credentials (username and password) as well as details of the website or application.

93. A system as claimed in claim 92, wherein the code comprises code for performing step (d) by launching the application or website with the login credentials pre-populated from the vault.

94. A system as claimed in claim 92, wherein the code comprises code for storing, as part of the login credentials, at least one of a One-Time Password, a PKI certificate, and Biometric information.

95. A system as claimed in claim 92, wherein the code comprises code for using the login credentials to Single Sign-On to a website or the application.

96. A system as claimed in claim 87, wherein the code comprises a Malware Analyzer for checking a webpage accessed through the custom browser prior to being displayed.
